(19) United States
(12) Patent Application Publication
(10) Pub. No.: US 2006/0076036 A1
(43) Pub. Date: Apr. 13, 2006

(54) Metal removal from solvent

(76) Inventors: Bruce J. Whitefield, Camas, WA (US); Gregory F. Piatt, Welches, OR (US); Michael S. Gatov, Gresham, OR (US)

Correspondence Address: LSI LOGIC CORPORATION, 1621 BARBER LANE, MS: D-106, MILPITAS, CA, 95035, US

(21) Appl. No.: 10/963,255

(22) Filed: Oct. 12, 2004

(51) Int. Cl. B08B 7/04; B08B 3/04

(52) U.S. Cl. 134/10; 134/104.2; 134/104.4

(57) ABSTRACT

An apparatus for cleaning a substrate. A cleaning chamber contacts the substrate with a cleaning solution. The cleaning solution thereby removes contaminants from the substrate and additionally leaches material from the substrate. A gettering chamber receives the cleaning solution, and includes a surface for chemically attracting the leached material and precipitating the leached material at least in part out of the cleaning solution. By removing the leached copper from the cleaning solution In this manner, the various embodiments of the present invention reduce the amount of copper that is available for plating out of the solvent, and therefore reduces the number and size of nodules that can form on the substrate. Thus, the need for other expensive approaches, like chemical replacement or less effective cleaning solvents, is obviated. The aluminum that is preferably used in the plating cell not only has an affinity to collect copper, but it is also known to be compatible with the solvent and substrates, since it is already present in abundance on the substrates themselves.

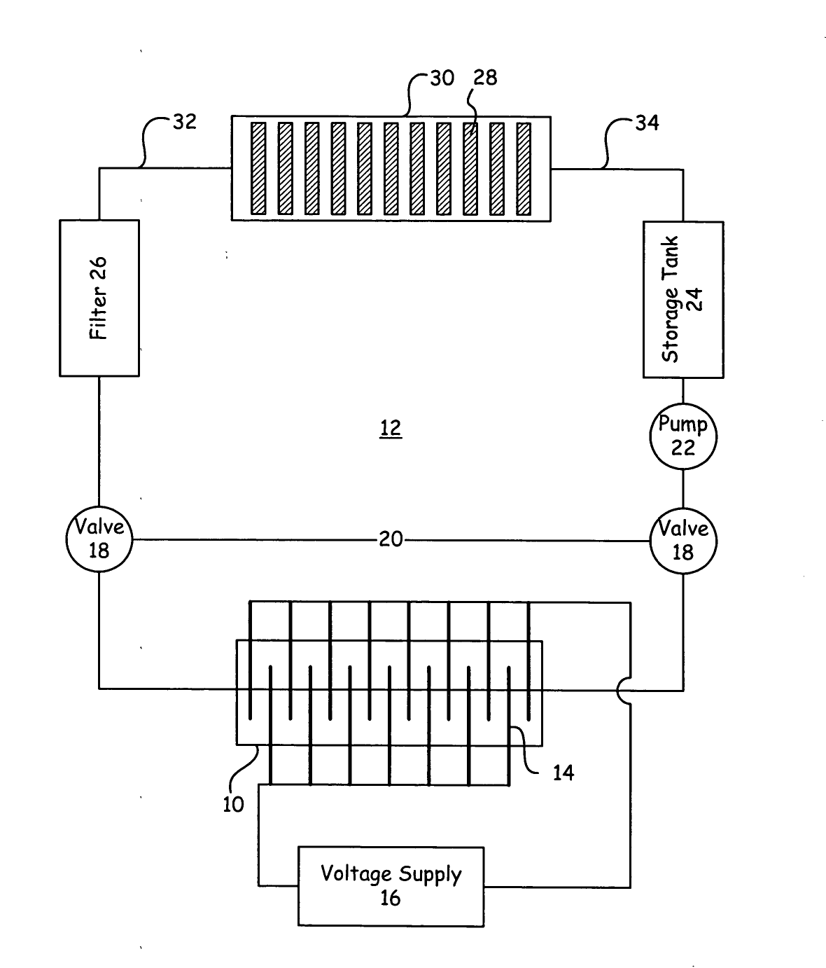

### FIELD

This invention relates to the field of integrated circuit fabrication. More particularly, this invention relates to removing residues from the reusable chemicals that are used in integrated circuit fabrication.

### BACKGROUND

As the term is used herein, “integrated circuit” includes devices such as those formed on monolithic semiconducting substrates, such as those formed of group IV materials like silicon or germanium, or group III-V compounds like gallium arsenide, or mixtures of such materials. The term includes all types of devices formed, such as memory and logic, and all designs of such devices, such as MOS and bipolar. The term also comprehends applications such as flat panel displays, solar cells, and charge coupled devices.

During the processing of substrates, such as silicon wafers, to make integrated circuits, a number of cleaning processes are used. One important category of processes uses a chemical solvent to remove polymers that form on the substrate during previous processes, such as a via etch or aluminum metal etch, where photoresist residue can be redeposited within the etched structures. The chemicals used for this purpose are typically ester-amines that are very good as dissolving the polymers, while leaving other integrated circuit fabrication materials, such as aluminum, silicon oxides, titanium, and titanium nitride substantially intact.

The problem is that the aluminum structures being etched typically contain a small amount of copper to form an alloy that is more resistant to electromigration effects. In more advanced processes, a substantially pure copper line is formed using a damascene process instead of a subtractive etch. The solvents that are effective for polymer removal generally have a small degree of metal etching capability, because the polymer is a matrix of organic residues and metal atoms. As a result, the solvent tends to acquire a significant amount of copper in solution after a number of substrates have been processed.

The copper in solution has a tendency to precipitate out onto the subsequent substrates that are processed through the solvent tool. If dense enough, these precipitated copper nodules tend to form a conductive path between metal lines, and can result in an electrical short and device failure. In some applications, such as on-axis rotational cleaning equipment, the precipitated copper nodules tend to cluster in the center of the substrate, where the solvent spray action is most limited and the solvent layer is relatively static.

A number of solutions to this problem have been explored with various degrees of success. The first approach is to use solvents that have a reduced tendency to dissolve copper into solution and subsequently precipitate it. The problem with this approach is that these chemicals also have reduced polymer removal efficiency, which lengthens the process time, and also tends to cause other yield problems due to incomplete removal of the polymer.

Another approach is to modify the upstream metal etch process to reduce the polymer formation. This option limits the choice of etch chemistries and conditions, which also lengthens the process time and increases the minimum line and space width that can be achieved by the process. Yet another approach is to add a chelating agent to the solvent that helps keep the copper in solution. While this is an improvement over the original process, it is not fully effective, and generally increases the cost of the solvent chemical.

Still another approach is to change the solvent processing tool from a spray processor to a solvent bath type. This can cost several million dollars in capital expense, and the bath process itself is not immune to the problem, but tends to simply distribute the copper nodules more randomly across the substrate instead of in the center of the substrate. Another approach is to frequently replace the solvent with fresh chemicals. This can be effective at eliminating the defect, but is very expensive because it greatly reduces the number of substrates that can be processed per gallon of solvent.

What is needed, therefore, is a system that overcomes problems such as those described above, at least in part.

### SUMMARY

The above and other needs are met by an apparatus for cleaning a substrate. A cleaning chamber contacts the substrate with a cleaning solution. The cleaning solution thereby removes contaminants from the substrate and additionally leaches material from the substrate. A gettering chamber receives the cleaning solution, and includes a surface for chemically attracting the leached material and precipitating the leached material at least in part out of the cleaning solution.

By removing the leached copper from the cleaning solution in this manner, the various embodiments of the present invention reduce the amount of copper that is available for plating out of the solvent and onto the substrates, and therefore reduces the number and size of nodules that might form on the substrate. Thus, the need for other expensive approaches, like chemical replacement or less effective cleaning solvents, is obviated. The aluminum that is preferably used in the plating cell not only has an affinity to collect copper, but is also known to be compatible with both the solvent and the substrates, since it is already present in abundance on the substrates themselves.

In various embodiments, the cleaning solution is a solvent, the leached material is copper, the surface includes aluminum, the contaminant is a polymer, and the substrate is semiconducting wafer on which integrated circuits are fabricated. The surface is preferably a plurality of plates disposed in a baffle through which the cleaning solution flows.

According to another aspect of the invention there is described an apparatus for cleaning a substrate. A cleaning chamber contacts the substrate with a cleaning solution. The cleaning solution removes organic contaminants from the substrate and additionally leaches copper from structures on the substrate. The cleaning chamber is configured as at least one of a spray chamber and a bath. A filter removes impurities from the cleaning solution, and a gettering chamber receives the cleaning solution. The gettering chamber includes a plurality of aluminum plates disposed in a baffle through which the cleaning solution flows, for chemically attracting the leached copper and precipitating the leached copper at least in part out of the cleaning solution. A voltage supply is electrically connected to the aluminum plates, for providing an electrical potential to the aluminum plates and enhancing an electrochemical attraction between the aluminum plates and the leached copper. A bypass valve selectively bypasses a flow of the cleaning solution around the gettering chamber. A pump circulates the cleaning solution between the cleaning chamber and the gettering chamber. A storage chamber stores the cleaning solution.

According to yet another aspect of the invention there is described a method for cleaning a substrate. The substrate is contacted with a cleaning solution, thereby removing organic contaminants from the substrate and additionally leaching copper from structures on the substrate into the cleaning solution. The cleaning solution is passed through a plurality of plates disposed in a baffle, thereby chemically attracting the leached copper and precipitating the leached copper at least in part out of the cleaning solution. The cleaning solution is reused to clean additional substrates.

In various embodiments of this aspect of the invention, impurities are filtered from the cleaning solution. A flow of the cleaning solution is preferably selectively bypassed around the plurality of aluminum plates. Preferably, an electrical potential is applied to the plurality of aluminum plates, thereby enhancing an electrochemical attraction between the plurality of aluminum plates and the leached copper. In some embodiments, the steps of contacting the substrate with the cleaning solution and passing the cleaning solution through a plurality of aluminum plates are accomplished in separate pieces of equipment.

### BRIEF DESCRIPTION OF THE DRAWINGS

Further advantages of the invention are apparent by reference to the detailed description when considered in conjunction with the FIGURE, which is not to scale so as to more clearly show the details, wherein like reference numbers indicate like elements, and which depicts an apparatus according to a preferred embodiment of the present invention.

### DETAILED DESCRIPTION

One aspect of the present invention is to use the affinity that aluminum has to precipitate and absorb copper to create a device that removes at least some, and most preferably substantially all, of the copper from the solvent solution.

The FIGURE depicts a functional block diagram of a copper gettering cell 10, connected to a solvent bath circulation system 12. The solvent is preferably circulated through an absorption cell 10 that removes the copper from the solvent. The absorption or gettering cell 10 preferably has aluminum plates 14 to collect the copper out of the solvent solution. The collection efficiency can be increased by adding a voltage supply 16 that maintains a voltage potential across the plates 14 to increase the copper plating rate, and also by increasing the size of the aluminum plates 14.

The gettering cell 10 can preferably be selectively bypassed, such as by using valves 18 and bypass line 20. A pump 22 preferably provides the circulation for the solvent through the system 12. A storage tank 24 hold the solvent when it is not otherwise being used, or holds an amount of the solvent above that which is needed throughout the rest of the system 12. A filter 26 may be used to filter out large impurities and contaminants from the solvent.

The solvent preferably contacts the substrates 28 in a cleaning chamber 30, which may be configured as at least one of a spray chamber or a bath. The used solvent preferably leaves the cleaning chamber 32 through a drain line 32, which preferably leads to the filter 26 and gettering chamber 10. The refreshed solvent preferably arrives at the cleaning chamber 30 through the supply line 34.

Thus, the various embodiments of the present invention reduce the amount of copper that is available for plating out of the solvent, and therefore reduces the number and size of nodules that can form on the substrate. In this manner, the need for other expensive approaches, like chemical replacement or less effective cleaning solvents, is obviated. The aluminum that is used in the plating cell 10 not only has an affinity to collect copper, but it is also known to be compatible with the solvent and substrates, since it is already present in abundance on the substrates themselves.

An alternate way to use this invention is to use a plating material other than aluminum. As described above, aluminum has advantages, but there are other conductive materials like titanium or titanium nitride that could also be used. The copper depletion operation does not have to be done inline as illustrated in the FIGURE, but could alternately be done outside the process tool as a chemical cleaning and recycle operation. This would require that the chemical in the substrate process tool be replaced at some frequency, but the efficiency of a central, high volume solvent clean and remanufacture operation may be preferred for some operations. This approach has the advantage of only needing a single, large plating cell 10 instead of one for each solvent processing tool. The net effect on chemical cost and copper nodule reduction would be about the same as the prior embodiment.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An apparatus for cleaning a substrate, the apparatus comprising:
a cleaning chamber for contacting the substrate with a cleaning solution, the cleaning solution thereby removing contaminants from the substrate and additionally leaching material from the substrate, and
a gettering chamber for receiving the cleaning solution, the gettering chamber including a surface for chemically attracting the leached material and precipitating the leached material at least in part out of the cleaning solution.

2. The apparatus of claim 1, wherein the cleaning solution is a solvent.

3. The apparatus of claim 1, wherein the leached material is copper.

4. The apparatus of claim 1, wherein the surface includes at least one of aluminum, titanium, and titanium nitride.

5. The apparatus of claim 1, wherein the substrate is semiconducting wafer on which integrated circuits are fabricated.

6. The apparatus of claim 1, wherein the cleaning chamber comprises a spray chamber.

7. The apparatus of claim 1, wherein the cleaning chamber comprises a bath.

8. The apparatus of claim 1, wherein the surface is a plurality of plates.

9. The apparatus of claim 1, wherein the surface is a plurality of plates disposed in a baffle through which the cleaning solution flows.

10. The apparatus of claim 1, further comprising a storage chamber for storing the cleaning solution.

11. The apparatus of claim 1, further comprising a pump for circulating the cleaning solution between the cleaning chamber and the gettering chamber.

12. The apparatus of claim 1, further comprising a filter for removing impurities from the cleaning solution.

13. The apparatus of claim 1, further comprising a bypass valve for bypassing a flow of the cleaning solution around the gettering chamber.

14. The apparatus of claim 1, further comprising a voltage supply electrically connected to the surface for providing an electrical potential to the surface and enhancing an electrochemical attraction between the surface and the leached material.

15. An apparatus for cleaning a substrate, the apparatus comprising:
a cleaning chamber for contacting the substrate with a cleaning solution, the cleaning solution thereby removing organic contaminants from the substrate and additionally leaching copper from structures on the substrate, where the cleaning chamber is configured as at least one of a spray chamber and a bath,
a filter for removing impurities from the cleaning solution,
a gettering chamber for receiving the cleaning solution, the gettering chamber including a plurality of aluminum plates disposed in a baffle through which the cleaning solution flows for chemically attracting the leached copper and precipitating the leached copper at least in part out of the cleaning solution,
a voltage supply electrically connected to the aluminum plates for providing an electrical potential to the aluminum plates and enhancing an electrochemical attraction between the aluminum plates and the leached copper,
a bypass valve for bypassing a flow of the cleaning solution around the gettering chamber,
a pump for circulating the cleaning solution between the cleaning chamber and the gettering chamber, and
a storage chamber for storing the cleaning solution.

16. A method for cleaning a substrate, the method comprising the steps of:
contacting the substrate with a cleaning solution, thereby removing organic contaminants from the substrate and additionally leaching copper from aluminum structures on the substrate into the cleaning solution,
passing the cleaning solution through a plurality of plates disposed in a baffle, thereby chemically attracting the leached copper and precipitating the leached copper at least in part out of the cleaning solution, and
reusing the cleaning solution to clean additional substrates.

17. The method of claim 16, wherein the plurality of plates further comprises aluminum plates.

18. The method of claim 16, further comprising selectively bypassing a flow of the cleaning solution around the plurality of plates.

19. The method of claim 16, further comprising providing an electrical potential to the plurality of plates, thereby enhancing an electrochemical attraction between the plurality of plates and the leached copper.

20. The method of claim 16, wherein the steps of contacting the substrate with the cleaning solution and passing the cleaning solution through a plurality of plates are accomplished in separate pieces of equipment.
